(19) United States
(12) Patent Application Publication
(10) Pub. No.: US 2026/0145394 A1
(43) Pub. Date: May 28, 2026

(54) SYSTEMS AND METHODS FOR CARRYING OUT A RESIN TRANSFER MOLDING PROCESS WITH MULTIPLE INJECTION TECHNOLOGY

(71) Applicant: JetZero, Inc., Long Beach, CA (US)

(72) Inventor: Dirk Kraemer, Rhineland-Palatinate (DE)

(73) Assignee: JetZero, Inc., Long Beach, CA (US)

(21) Appl. No.: 19/012,082

(22) Filed: Jan. 7, 2025

Related U.S. Application Data
(60) Provisional application No. 63/724,055, filed on Nov. 22, 2024.

(51) Int. Cl. B29C 70/48; B29C 33/10; B29C 37/00; B29K 707/04

(52) U.S. Cl. CPC B29C 70/48; B29C 33/10; B29C 37/00; B29C 2037/906; B29K 2707/04

(57) ABSTRACT

A system for carrying out a Resin Transfer Molding process including a molding tool having an upper mold half and a lower mold half which form a mold cavity configured for placement of a preform, a main control unit, more than one injection units configured to supply a resin mixture into the mold cavity, more than one injection points fluidly connecting the more than one injection units to the molding tool, one or more venting hoses configured to expel an excess of the resin mixture, more than one resin outlets fluidly connecting the one or more venting hoses to the molding tool and one or more flow direction sensors connected to the main control unit, wherein the main control unit is configured to monitor a behavior of the resin mixture from the more than one injection points to the mold cavity using the one or more flow direction sensors.

### CROSS-REFERENCE TO RELATED APPLICATIONS

This application claims the benefit of priority of U.S. Provisional Patent Application Ser. No. 63/724,055, filed on Nov. 22, 2024, and titled “A system for carrying out an RTM (Resin Transfer Molding) process with multiple injection technology,” which is incorporated by reference herein in its entirety.

### FIELD OF THE INVENTION

The present invention generally relates to the field of Resin Transfer Molding. In particular, the present invention is directed to systems and methods for carrying out a resin transfer molding process with multiple injection technology.

### BACKGROUND

The RTM process (Resin Transfer Molding) is a manufacturing process for producing fiber composite material components with excellent strength properties and low weight. It enables the production of complex geometries with high precision and very good reproducibility. However, when manufacturing large components, current systems and methods for RTM may result in limited design flexibility and a higher risk of uneven resin distribution, dry spots and longer cycle times.

### SUMMARY OF THE DISCLOSURE

In an aspect, a system for carrying out an RTM (Resin Transfer Molding) process is described. The system includes a molding tool having an upper mold half and a lower mold half, wherein the upper mold half and lower mold half form a mold cavity configured for placement of a preform. The system further includes a main control unit, more than one injection units configured to supply a resin mixture into the mold cavity, more than one injection points fluidly connecting the more than one injection units to the molding tool, one or more venting hoses configured to expel an excess of the resin mixture within the mold cavity and more than one resin outlets fluidly connecting the one or more venting hoses to the molding tool. The system further includes one or more flow direction sensors communicatively connected to the main control unit, wherein the main control unit is configured to monitor a flow behavior of the resin mixture from the more than one injection points to the mold cavity using the one or more flow direction sensors.

In another aspect, a method for carrying out an RTM (Resin Transfer Molding) process is described. The method includes receiving a molding tool having an upper mold half and a lower mold half, wherein the upper mold half and lower mold half form a mold cavity configured for placement of a preform, flowing, using more than one injection units, a resin mixture into the mold cavity, wherein the more than one injection units are fluidly connected to the molding tool through more than one injection points and sensing, using one or more flow direction sensors, flow data of the resin mixture. The method further includes receiving, by a main control unit communicatively connected to the one or more flow direction sensors, the flow data and monitoring, by the main control unit, a flow behavior of the resin mixture from the more than one injection points to the mold cavity using the flow data.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of a system for carrying out a resin transfer molding (RTM) process;

FIG. 2A is a schematic representation of a system with a molding tool with a semi-finished fiber product of uniform thickness inserted;

FIG. 2B is a schematic representation of the system with the molding tool with a semi-finished fiber product of different thickness inserted;

FIG. 3 is a representation of one or more exemplary components for implementing a multiple-injection RTM process;

FIG. 4 is a schematic representation of a main control device 201 and one an exemplary injection unit for a multiple-injection RTM system;

FIG. 5 is a simplified representation of flow fronts at six injection points P1 to P6;

FIG. 6 is a flow diagram illustrating an exemplary method for carrying out a resin transfer molding process; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In a Resin Transfer Molding (RTM) process, dry reinforcing materials such as glass or carbon fibers may be placed in a mold cavity. The mold may then be closed, creating a sealed environment. Resin may then be injected into the cavity under pressure, impregnating the reinforcing materials and filling the mold. The resin may contain additives such as catalysts or hardeners to initiate curing or cross-linking reactions. The mold can be evacuated and heated to improve the flow behavior of the resin (viscosity reduction) and to initiate or accelerate the curing process.

Once the resin has completely impregnated the reinforcing materials and cured, the mold may be opened, and the finished component may be removed.

In one or more embodiments, the RTM process may be carried out at low pressure (up to about 203 bar) and low temperature (up to about 270° C.), which can be particularly suitable for the production of composite parts.

In a high-pressure RTM process, a higher pressure (up to about 240 bar) may be used, which allows faster resin flow. However, there is a risk that the reinforcing fibers will displace impermissibly due to the increased injection pressure and the fiber orientation in the component will not match the planned specification. This mechanism can be difficult to produce large-sized components with high fiber-volume ratios using the RTM process.

In some instances, the resin and tool temperature may be increased for shorter processing times. This may result in lower viscosity and thus a higher flow rate of the resin. Heating also reduces the time required for the curing process. If the resin temperature is increased over a longer period of time during the production of large components with long resin flow paths, the curing reaction can be initiated too quickly. Due to the gelling of the resin at the beginning of the curing reaction, the resin flow may be impeded and can come to a complete stop before the entire mold is filled. The reinforcing fibers may be insufficiently impregnated and the component may not achieve the required properties.

Resin delivery can be done by means of an injection apparatus that injects the resin (in the correct mixing ratio with the hardener required for 2K systems) into the molding tool via a mixing head. In one or more embodiments, an RTM system may employ an injection apparatus with a single injection point (single-point injection system). When manufacturing large components, a single injection point may result in limited design flexibility and pose a higher risk of uneven resin distribution, dry spots and longer cycle times. Particularly in the aerospace industry, where the demand for lightweight, high-strength components is especially high, conventional RTM processes may problems ensuring consistent production of composite material parts.

The RTM process may be used to manufacture integral components. The RTM process may include a resin infusion process and may be used to manufacture fiber composite components. Resin Transfer molding or Resin Transfer Molding (RTM) may include a process for manufacturing molded parts from thermosets and elastomers. In contrast to pressing, the molding compound may be injected by means of a piston from a usually heated pre-chamber or distribution channel into the mold cavity, where it hardens under heat and pressure.

Formaldehyde resins (PF, MF, etc.) and reactive resins (UP, EP) with small filler particles and elastomers can be used as molding materials. At the beginning of a cycle, a pre-plasticized and metered molding compound may be located in a pre-chamber. First, the tool may be closed. Then the molding compound may be injected into the tool and left in the tool for a certain time. During this so-called dwell time, the molding compound may react or vulcanize. This may depends on various factors (e.g., resin type, filler, processing pressure and temperature).

Once the dwell time has elapsed, the tool can be opened. The previously injected molding compound may now be solid (cured) and referred to as a ‘molded part’. This can now be removed from the tool. The tool may then be cleaned and a new cycle can begin. The molding compound required for injection and re-injection may be larger than the final molded part so that the tool is completely filled. This can ensure that the molded part is fully formed, and no air is pressed in. The excess molding compound remaining in the pre-chamber, also known as the residual cake, may be removed and replaced with new molding compound before the start of the new cycle.

To process long fibers or semi-finished fiber products (prewovens/preforms/preforming), the long fibers or semi-finished products may first be placed in the tool and then encapsulated with the molding compound. To avoid air inclusions, the cavity (hollow mold space) may also be evacuated. Injection resins used for this purpose may contain low-viscosity resins. This keeps the flow resistance when flowing through the mold low, and smaller pressure differences are required for filling. Reactive resins for the RTM process may be offered as special injection resins containing a resin and hardener component. During the injection process in the RTM method, resin flows at the appropriate flow rate through the mold cavity, filling it, wetting the inserted materials and exiting the tool.

All the above solutions may have a disadvantage that, in particular, very large integral components, such as those required for aircraft, wind turbines and the like may not be produced in high quality using multiple injection.

In one or more embodiments, aspects of the present disclosure include a system for carrying out an RTM (Resin Transfer Molding) process using multiple injection technology, which ensures reliable penetration of the semi-finished product placed in a mold with the injected resin mixture/resin-hardener mixture and a high quality of the parts produced with multiple injections, i.e. injection of the resin mixture at several injection points in the tool.

This task may solve with the features as described herein. Advantageous configurations may also arise as described herein.

In one or more embodiments, the present disclosure may include a system for carrying out a Resin-Transfer-Molding process (RTM) with a molding tool, which has an upper mold half and a lower mold half with a mold cavity formed in between for inserting a preform, is equipped with a main control device and has several injection units for supplying resin mixture into the mold cavity, wherein a plurality of injection points of the injection units lead into the molding tool and into the mold cavity thereof and sensors for monitoring process parameters are integrated in the molding tool and/or the injection units and the sensors communicate with the main control device.

In one or more embodiments, the main control device may be used to control the injection units and to change the pressure and/or volume of the injected resin mixture depending on parameters in the molding tool.

Sensors may be integrated into the molding tool to detect the flow behavior of the injected resin mixture. These sensors may include flow detection sensors in the form of pressure, optical and/or ultrasonic sensors. In one or more embodiments ultrasonic sensors may be effective for detecting the flow fronts.

In one or more embodiments, at least one capacitive sensor may arranged on a venting hose at least one resin outlet of the molding tool.

In one or more embodiments, the capacitive sensor may be used to detect resin leakage at the resin outlet and to detect air bubbles in the emerging resin mixture.

In one or more embodiments, the main control device may include the “brain” of the plant (master) or system and is connected to the injection units for the transmission of commands.

In one or more embodiments, the sensors integrated into the molding tool may transmit the recorded data to the main control device in real time.

In one or more embodiments, the main control device may be used to display critical data and, in particular, the status of an RTM process on the basis of the data continuously transmitted in real time.

In one or more embodiments, the main control device can be used to analyze data from the molding tool to assess the performance of each individual injection unit and the resin distribution within the mold. The main control device allows the actual process parameters to be compared with predefined targets or setpoints, in particular to determine whether adjustments are required.

If adjustments are required, the main control device transmits modified parameters to each individual injection unit, so that each injection unit can implement these settings independently. For example and without limitation, the pressure, volume, mixing ratio of resin/hardener, temperature of the resin mixture and, of course, a combination of the above parameters can be changed by the main control device using the appropriate commands.

Furthermore, as already described above, the position of flow fronts can be determined by the data transmitted to the main control device by the sensors. By detecting resin flow fronts, the main control device can determine where resin flow fronts will meet.

A major advantage of the system is that it is now possible for the first time to direct an area of the resin flow fronts meeting at a resin outlet and/or a vent opening of the molding tool via the main control device. This is possible, for example, by the fact that the speed of flow fronts can be varied by changing the injection pressure and/or the flow volumes of the individual injection units, in order to direct several flow fronts to a resin outlet and/or a vent opening of the molding tool.

On the outlet side, at least one sensor for detecting air bubbles in the resin mixture may be present at the resin outlet or in an area (hose) downstream of the resin outlet. A capacitive sensor and/or an optical sensor may be used as the sensor for detecting air bubbles.

The area where the sensor or sensors for detecting air bubbles are arranged may be designed as a transparent area in an area through which the resin mixture flows, with the capacitive sensor and/or the optical sensor being arranged on the outside of the transparent area.

The sensor(s) for detecting air bubbles may be connected to the main control device and transmit information to it about the amount of air bubbles present in the resin mixture, whereupon a signal can be transmitted from the main control device to the resin closing unit(s) to automatically close the resin outlets when there are no or almost no air bubbles in the resin being discharged or to open or keep open the outlets when there are still air bubbles in the resin mixture.

Furthermore, the main control may be coupled to the heating device of the molding tool and/or the heating devices of the storage container and/or the lines through which the resin-hardener mixture flows, in order to monitor and control a start-up curve and to achieve a specified target temperature. The main control device stores the energy introduced and the resulting outcome and independently controls the higher circulation temperature of the heating medium that is required to reach the operating temperature. This also takes into account the power loss through the supply lines and the waste heat of the tool. A percentage limit on the desired temperature prevents the introduction of too much energy.

At least one venting hose may be arranged on the output side of the molding tool, for example in or after one or more resin outlets, through which the air present in the resin mixture can escape. A filling level of the venting hose can be monitored and/or an air bubble quantity and/or an air bubble size in the resin mixture can be determined using at least one capacitive and/or optical sensor. These characteristic values are then visualized for the operator in the system control.

The sensor(s) for detecting the filling level of the venting hose and/or the amount of air bubbles and/or the size of air bubbles may be connected to the main control device and the current amount of air bubbles and/or the size of air bubbles can be determined at the at least one resin outlet. This characteristic value is used by the control logic to automatically open and close the resin outlets (resin flow closing unit) for the purpose of automated venting of the component to be injected. By comparing with a predefined maximum value of the filling state of the venting hoses, the component is automatically injected or vented until the maximum air bubble limit value is reached.

In one or more embodiments, methods described herein may include a continuous real-time communication system for the multiple-injection RTM process.

The multiple-injection RTM system may ensures efficient coordination between the main control device, the individual injection units and the sensors in and on the molding tool during the entire multiple-injection RTM process, including the injection and curing process. The main control device serves as the “brain” of the system (master) and seamlessly transmits commands to the individual injection units, which act as the executors of the commands (slave). All sensors embedded in the molding tool continuously transmit critical data in real time to the main control device, providing insight into the status and dynamics of the RTM process. The main control device analyses the data transmitted by the sensors in the molding tool to evaluate the performance or parameters of each individual injection unit and the resin distribution within the molding tool/mold cavity with the preform inserted and compares the actual process parameters with predefined targets or setpoints stored in the main control device to determine whether adjustments are required. Based on the analysis of the data from the sensors, the main control device communicates the modified parameters to each individual injection unit so that each injection unit can receive and implement these settings independently of each other.

Another inventive aspect of the multiple-injection RTM process may include the detection and control of resin flow fronts in the closed tool. The position of the flow fronts can be detected by means of the real-time communication between the sensors used in the molding tool and the main control device described above. The flow fronts are detected by combining the data from the tool sensors (flow detection sensors (pressure, optical and/or ultrasonic sensors) and the capacitive and/or optical sensor on the venting hose transmitted to the main control device. By detecting resin flow fronts, the main control device can determine/calculate at which points the resin flow fronts of the resin mixture, which has been injected into the tool via the individual injection points, will meet. If it is determined that the flow fronts will not meet in the area of a resin outlet, the flow fronts are directed towards the resin outlet. This will direct the area where the flow fronts meet to a venting point-preferably a resin outlet.

In one or more embodiments, the injection process, including control of the resin flow fronts in the closed tool, may be automatically controlled by the main control device. The following process steps may be carried out. The sensors and their communication with the main control device and in turn their communication with all injection units is implemented to achieve an even resin distribution over the entire preform during sequential injection or injection with variable pressure, which cannot be observed in the closed mold. The system analyses the data from the mold sensors in real time and calculates the required injection quantity of each injection unit at the assigned injection points to control the flow fronts. It adjusts the speeds of the flow fronts by changing the injection pressure and/or the flow volumes of the individual injection units in order to guide the flow fronts to the respective venting points (resin outlets). The option of using and controlling several injection points through several injection units for very large components makes it possible to shorten the flow paths and thus significantly reduce the internal pressure of the tool in the area of the injection point. The injection time is shortened. However, to prevent the possibility of areas with an inclusion or insufficient resin content being created by a purge when several flow fronts collide, the flow fronts are actively adjusted.

Another important aspect of the process and system according to the invention may include the detection of air bubbles at the resin outlets. The multi-injection RTM system can detect air bubbles in the resin system that escape from the resin outlets by using capacitive sensors and/or optical sensors. In addition, these sensors can measure the amount of air bubbles present in the resin system. The purpose of detecting air bubbles and measuring the amount of air bubbles is to ensure that the injection or flushing process is not completed until the component is completely filled and the limit values for the air volume in the resin-hardener mixture are not exceeded before the injection is complete.

Another advantage of the solution according to the invention may include the automatic venting of air bubbles at the resin outlet(s). This is described as follow. Based on the detection of air bubbles by means of capacitive sensors and/or optical sensors at the resin outlet(s), information about the amount of air bubbles present in the resin mixture is forwarded to the main control device. Based on this information, the multiple-injection RTM system can modify the process parameters of individual injection units or multiple injection units simultaneously to ensure that no air bubbles are present in the mold. After the process parameters of the injection units have been modified, the multi-injection RTM system can analyze the changes based on data from capacitive sensors and/or optical sensors and send a signal to the resin closing unit to automatically close and open the resin outlets.

The process may also involve an automatic reduction of the tool pressure by means of a control logic, which is described as follow. The internal pressure in the mold and the pressure at the injection points are continuously monitored by the multiple-injection RTM system using the pressure sensors located in the mold and on the mixing head. The multiple injection RTM system can independently detect the areas with excessive pressure (above the defined limit) and open a resin outlet in this area through communication with the resin closing unit or the control parameters of the injection units until the pressure is back within the limit range. In this variant, one or more resin outlets are opened to reduce the internal pressure in the molding tool to a predetermined maximum value or below. This is similar to the description of variable pressure control. With variable pressure control, the pressure is controlled by the pump output of the resin injection pumps. The internal pressure can also be reduced by reducing the pump pressure. Alternatively, if the tool inner pressure is too high, both the resin outlets can be opened and the pump pressure reduced in order to bring the mold internal pressure below a specified maximum pressure.

When the limit values set in the main control device are reached, the delivery volume is preferably adjusted first and then constantly reduced. The respective resin outlets located in the area of the pressure evaluation unit of the molding tool W can be opened alternatively or additionally if reducing the internal mold pressure by reducing the delivery volume was insufficient. This results in an automatic reduction of the internal mold pressure by the control logic of the main control.

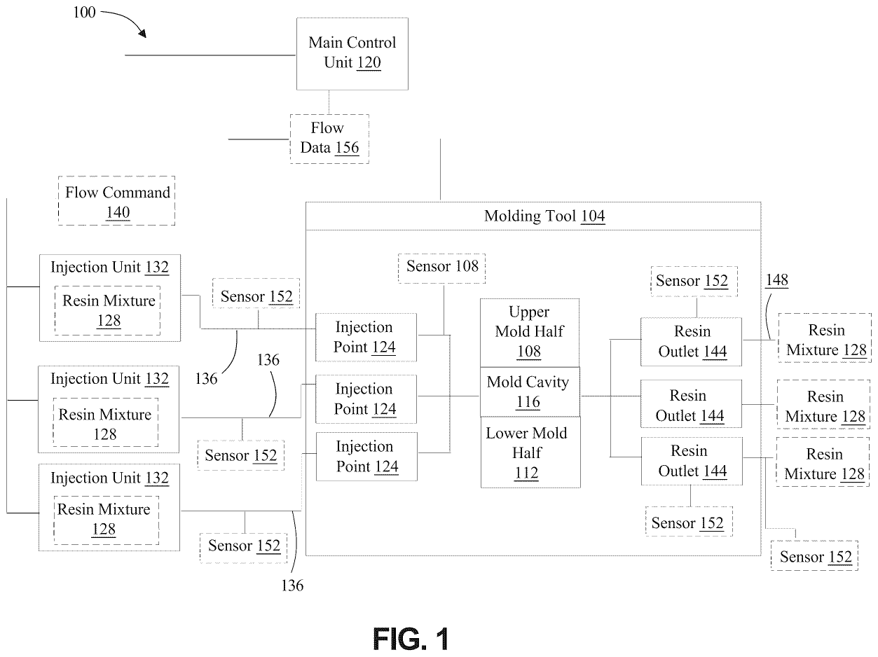

Referring now to FIG. 1, an exemplary embodiment of a system 100 for carrying out a resin transfer molding (RTM) process is described. In one or more embodiments, system 100 includes a molding tool 104. A “molding tool,” for the purposes of this disclosure, is a device used to create molded parts. In one or more embodiments, a molded part may include a material that has been formed into a desired shape. In one or more embodiments, a molded part may include a material that has been hardened following a molding process. In one or more embodiments, a molded part may include a material, such as a carbon fiber material that has been infused with a resin. In one or more embodiments, molded part may include a pliable material that has been made nonpliable following a molding process. In one or more embodiments, molding tool 104 may be used to create molded part. In one or more embodiments, molding tool includes any molding tool as described in this disclosure. In one or more embodiments, molding tool may include an upper mold half 108 and a lower mold half 112. In one or more embodiments, upper mold half 108 and lower mold half 112 may include two sides of a mold in which molded part is placed between. In one or more embodiments, upper mold half 108 and lower mold half 12 may contain grooves, and/or other defining features that define the features of molded part. In one or more embodiments, a material such as carbon fiber cloth and/or strands may be placed within a cavity 116 defined by the empty space between upper mold half 108 and lower mold half 112. In one or more embodiments, cavity may include an open portion between upper mold half 108 and lower mold half when upper mold half 108 and lower mold half 112 are placed together. In one or more embodiments, cavity 116 and/or mold cavity may be used interchangeably throughout this disclosure. In one or more embodiments, mold cavity may include a portion within a mold that allows for a preform and/or other components of the molded part to be placed. In one or more embodiments, a preform, resin and/or the like may be placed within a mold cavity, prior to a molding process, wherein the preform, resin and/or the like may be molded into a molded part.

With continued reference to FIG. 1, a preform may be placed within cavity. A “perform,” as described in this disclosure refers to a part of a portion thereof prior to a molding process. In one or more embodiments, preform may include a carbon fiber material such as for example, carbon fiber sheets, carbon fiber strands and/or the like. In one or more embodiments, preform may include a material in which a resin will be applied during molding process. In one or more embodiments, preform may include any preform as described in this disclosure. In one or more embodiments, preform may be configured to be infused and/or coated with a resin. In one or more embodiments, a preform and resin mixture may be hardened and referred to as a “molded part”.

With continued reference to FIG. 1, system 100 includes a main control unit 120. A “main control unit,” as described in this disclosure refers to a processing unit configured to receive data and execute one or more commands in relation to system 100. In one or more embodiments, main control unit 120 includes a computing device. Computing device includes a processor communicatively connected to a memory. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In one or more embodiments, the main control unit includes memory containing instructions configuring the main control unit to send and/or receive data.

Further referring to FIG. 1, computing device may include any computing device as described in this disclosure, including without limitation a microcontroller, microprocessor, digital signal processor (DSP) and/or system on a chip (SoC) as described in this disclosure. computing device may include, be included in, and/or communicate with a mobile device such as a mobile telephone or smartphone. computing device may include a single computing device operating independently, or may include two or more computing device operating in concert, in parallel, sequentially or the like; two or more computing devices may be included together in a single computing device or in two or more computing devices. computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing. In one or more embodiments, main control unit 120 may include any main control unit and/or main control device as described in this disclosure.

With continued reference to FIG. 1, main control unit 120 may be configured to receive data from one or more systems and/or devices as described in this disclosure. In one or more embodiments, main control unit 120 may be configured to process received data and transmit commands in any way as described in this disclosure. In one or more embodiments, main control unit 120 may be communicatively connected to one or more devices as described in this disclosure.

With continued reference to FIG. 1, system 100 and/or molding tool 104 includes one or more injection points 124. An “injection point,” as described in this disclosure is an opening within a molding tool that allows for a liquid to pass through a portion of the molding tool and into a cavity. For example, and without limitation, injection point may include one or more holes within upper mold half 108 and/or lower mold half 112 that allows for a resin to pass through upper mold half and/or lower mold half 112 and into cavity. In one or more embodiments, injection point 124 any injection point as described in this disclosure. In one or more embodiments, injection point 124 may provide for a fluidic connection to molding tool 104. In one or more embodiments, injection points 124 may be located on molding tool 104, on upper mold half 108 and/or on lower mold half 112. In one or more embodiments, injection points 124 may be used to fill cavity 116 with a resin mixture 128. In one or more embodiments, preform may be placed within cavity 116 wherein injection points 124 may be used to fill cavity 116 and soak preform with resin mixture 128. In one or more embodiments, preform may be placed within cavity 116 wherein cavity may still contain pockets of air. In one or more embodiments, resin mixture 128 may be used to fill any space within cavity 116 that is not occupied. In one or more embodiments, resin mixture 128 may be injected into cavity 116 following placement of mold. In one or more embodiments, resin mixture 128 and preform may form molded part. In one or more embodiments, molded part may include a composite containing preform and resin mixture 128. In one or more embodiments, injection points 124 may allow for access to within cavity in instances in which upper mold half 108 and lower mold half are placed together. In one or more embodiments, injection points may allow for resin mixture to travel from outside of molding tool 104 and into cavity 116. A “resin mixture,” as described in this disclosure refers to a combination of a liquid resin and a curing agent. In one or more embodiments, when the liquid resin and curing agent are mixed together, a chemical reaction occurs and solidifies the resin mixture. In one or more embodiments, resin mixture 128 may include any resin mixture as described in this disclosure. In one or more embodiments, resin mixture may include a resin and/or curing agent, such as but not limited to, epoxy resins, anhydride curing agents, acrylic resins, amine curing agents and/or the like. In one or more embodiments, system 100 may further use a resin without a curing agent.

With continued reference to FIG. 1, resin mixture 128 may be supplied by one or more injection units 132. An “injection unit,” as described in this disclosure is a device configured to supply a resin into a mold. In one or more embodiments, injection unit may be configured to melt resin plastic pellets into a molten state and injection the molten material under a high pressure into a mold. In one or more embodiments, injection unit 132 may be responsible for micing resin with a curing agent to create resin mixture 128 and supplying resin mixture 128 to molding tool 104. In one or more embodiment, injection unit may inject resin mixture into molding tool 104 and/or cavity 116.

by applying a pressure to resin mixture. In one or more embodiments, resin mixture 128 may travel to cavity through the application of pressure. In one or more embodiments, injection unit 132 may include any injection unit 132 as described in this disclosure. In one or more embodiments, injection tool may provide resin through an inlet pipe 136 that is fluidly connected to one or more injection points 124. In one or more embodiments, each injection unit 132 may contain its own inlet pipe that is configured to provide resin mixture 128 through one injection point 124. In one or more embodiments, system 100 may include a plurality of injection units 132 wherein each injection unit 132 is configured to provided resin mixture through a separate inlet pipe 136 and/or separate injection point 124. In one or more embodiments, inlet pipe 136 may include any component capable of transferring a liquid through the application of pressure. In one or more embodiments, inlet pipe 136 may include a hose and/or tube configured to transfer resin mixture from injection unit 132 to injection point 124. In one or more embodiments, injection unit may include any injection unit as described in this disclosure. In one or more embodiments, injection unit 132 may apply a pressure to resin mixture in order to resin mixture to travel from injection unit, though inlet pipe 136, through injection point 124 and into cavity 116. In one or more embodiments, injection unit 132 may be configured to transfer resin mixture 128 in any way as described in this disclosure. In one or more embodiments, resin mixture 128 may be injection into cavity through the application of pressure by injection unit 132. In one or more embodiments, injection unit 132 may control flow and/or rate of resin mixture by varying the pressure applied onto resin mixture 128. In one or more embodiments, injection unit 132 may store a resin and a catalyst that hardens the resin upon mixture. In one or more embodiments, injection unit may include a metering pump configured to control the amount of resin injected into molding tool 104 and/or cavity. In one or more embodiments, injection unit may include any pump as described in this disclosure. In one or more embodiments, pump may include a substantially constant pressure pump (e.g., centrifugal pump) or a substantially constant flow pump (e.g., positive displacement pump, gear pump, and the like). Pump can be hydrostatic or hydrodynamic. As used in this disclosure, a “pump” is a mechanical source of power that converts mechanical power into fluidic energy. A pump may generate flow with enough power to overcome pressure induced by a load at a pump outlet. A pump may generate a vacuum at a pump inlet, thereby forcing fluid from a reservoir into the pump inlet to the pump and by mechanical action delivering this fluid to a pump outlet. Hydrostatic pumps are positive displacement pumps. Hydrodynamic pumps can be fixed displacement pumps, in which displacement may not be adjusted, or variable displacement pumps, in which the displacement may be adjusted. Exemplary non-limiting pumps include gear pumps, rotary vane pumps, screw pumps, bent axis pumps, inline axial piston pumps, radial piston pumps, and the like. Pump may be powered by any rotational mechanical work source, for example without limitation and electric motor or a power take off from an engine. Pump may be in fluidic communication with at least a reservoir. In some cases, reservoir may be unpressurized and/or vented. Alternatively, reservoir may be pressurized and/or sealed.

In one or more embodiments, injection unit 132 may include a heating system configured to heat resin mixture in order to adjust the viscosity of resin mixture 128. In one or more embodiments, injection unit 132 may include a pressure monitoring system configured to identify and maintain a correct pressure for resin mixture during injection.

With continued reference to FIG. 1, main control unit may be communicatively connected to injection units 132. In one or more embodiments, main control unit 120 may be communicatively connected to each of a plurality of injection units 132. In one or more embodiments, main control unit 120 may be configured to control a flow of resin mixture 128 to molding tool 104. In one or more embodiments, main control unit 120 may be configured to transmit one or more flow commands 140 to one or more injection units 132. A “flow command,” as described in this disclosure is a set of instructions to modify one or more parameters of an injection unit. For example, and without limitation, flow command 140 may include instructions to decrease a rate of flow of resin mixture 128 from injection unit 132. In one or more embodiments, flow command may include but is not limited to, instructions to change a pressure, instructions to change a flow rate, instructions to alter the temperature of a resin mixture, instructions to alter a viscosity of resin mixture 128 and/or the like. In one or more embodiments, main control unit may control one or more injection units by transmitting flow commands to each of the one or more injection units. In one or more embodiments, flow command 140 may include any instructions and/or actions taken by main control unit as described in this disclosure to alter the flow of resin mixture 128 into cavity 116. In one or more embodiments, main control unit may include instructions configuring one or more injection units 132 to supply resin mixture and/or cease supply of resin mixture into cavity 116. In one or more embodiments, at least one flow command may include an injection pressure. An “injection pressure,” as described in this disclosure refers to the pressure applied on resin mixture. In one or more embodiments, injection pressure may vary in order to vary the flow rate of resin mixture 128 into cavity 116. In one or more embodiments, at least one flow command may include an injection flow volume. An “injection flow volume,” as described in this disclosure refers to the flow rate of the resin mixture. For example, without limitation injection flow volume may include a flow rate of 1 gallon per minute, 1 liter per minute, 1 milliliter per minute and/or the like. In one or more embodiments, flow command 140 may not only control the speed of resin mixture 128 but the rate that which resin mixture 128 is introduced into cavity. In one or more embodiments, the main control unit includes memory containing instructions configuring the main control unit to control the more than one injection units to supply the resin mixture within the mold cavity.

With continued reference to FIG. 1, system 100 may include one or more resin outlets 144. A “resin outlet,” for the purposes of this disclosure is an opening or channel within molding tool that allows for an excess resin mixture to escape from within a cavity. For example, and without limitation, in some instances injection unit may provide an excess of resin mixture 128. In one or more embodiments, the excess resin mixture may escape through the resin outlet 144. In one or more embodiments, resin outlet may include a feature or area in the mold that facilitates the exit of excess resin during the injection process. It may be part of the mold design and serve a critical role in ensuring proper resin flow, complete impregnation of the reinforcement material, and elimination of air or voids. In one or more embodiments, during a molding process an excess of resin may be injected into cavity 116 in order to ensure that air bubbles are not present within cavity. In one or more embodiments, an of excess resin mixtures 128 may escape from resin outlet once cavity 116. In one or more embodiments, resin outlet 144 may ensure that resin mixture 128 has reached all parts of the mold. In one or more embodiments, resin outlet may include an extruded portion of upper mold half 108 and/or lower mold half 112 that allows for an excess of resin mixture 128 to escape. In one or more embodiments, system 100 may include more than one resin outlets 144 wherein each resin outlet may allow for an excess of resin to escape from a differing portion of the mold and/or cavity 116. In one or more embodiments, resin outlet 144 may further serve as vent ports in order to allow for air within cavity 116 to escape and be replaced with resin mixture. In one or more embodiments, resin outlet 144 may include any outlet as described in this disclosure.

With continued reference to FIG. 1, system 100 may include one or more venting hoses 148 configured to expel an excess of resin mixture from within cavity 116 and/or mold cavity 116. A “venting hose,” for the purposes of this disclosure is a device configured to facilitate a flow of a fluid from within molding tool to outside of the molding tool. In one or more embodiments, venting hose 148 may include a pipe and/or hose configured to transport an excess of resin mixture. In one or more embodiments, venting hose 148 may include any venting hose and/or material capable of transporting a liquid as described in this disclosure. In one or more embodiments, venting hose may facilitate the release of air within cavity 116, of an excess resin mixture within cavity and/or the like.

With continued reference to FIG. 1, system 100 may include one or more sensors. As used in this disclosure, a “sensor” is a device that is configured to detect an input and/or a phenomenon and transmit information related to the detection. For example, and without limitation, a sensor may transduce a detected charging phenomenon and/or characteristic, such as, and without limitation, temperature, voltage, current, pressure, and the like, into a sensed signal such as a voltage with respect to a reference. Sensor may detect a plurality of data. A plurality of data detected by sensor may include, but is not limited to, battery quality, battery life cycle, remaining battery capacity, current, voltage, pressure, temperature, moisture level, and the like. In one or more embodiments, and without limitation, sensor may include a plurality of sensors. In one or more embodiments, and without limitation, sensor may include an optical or image sensor such as a camera, a CMOS detector, a CCD detector, a video camera, a photodiode, a photovoltaic cell, a photoconductive device, a thermal and/or infrared camera, one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, and the like. Sensor may be a contact or a non-contact sensor. Signals may include electrical, electromagnetic, visual, audio, radio waves, or another undisclosed signal type alone or in combination.

Still referring to FIG. 1, sensor may include a motion sensor. A “motion sensor”, for the purposes of this disclosure, refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. Sensor may include torque sensor, gyroscope, accelerometer, torque sensor, magnetometer, inertial measurement unit (IMU), pressure sensor, force sensor, proximity sensor, displacement sensor, vibration sensor, among others.

With continued reference to FIG. 1, sensor may include a pressure sensor. A “pressure”, for the purposes of this disclosure, and as would be appreciated by someone of ordinary skill in the art, is a measure of force required to stop a fluid from expanding and is usually stated in terms of force per unit area. In non-limiting exemplary embodiments, a pressure sensor may be configured to measure an atmospheric pressure and/or a change of atmospheric pressure. In some embodiments, a pressure sensor may include an absolute pressure sensor, a gauge pressure sensor, a vacuum pressure sensor, a differential pressure sensor, a sealed pressure sensor, and/or other unknown pressure sensors or alone or in a combination thereof. The pressor sensor may include a barometer. In some embodiments, the pressure sensor may be used to indirectly measure fluid flow, speed, water level, and altitude. In some embodiments, a pressure sensor may be configured to transform a pressure into an analogue electrical signal. In some embodiments, the pressure sensor may be configured to transform a pressure into a digital signal.

With continued reference to FIG. 1, sensor may include a moisture sensor. “Moisture”, as used in this disclosure, is the presence of water, which may include vaporized water in air, condensation on the surfaces of objects, or concentrations of liquid water. Moisture may include humidity. “Humidity”, as used in this disclosure, is the property of a gaseous medium (almost always air) to hold water in the form of vapor. In an embodiment, a moisture sensor may include a hygrometer. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. Humidity sensor may be psychrometer. Humidity sensor may be a hygrometer. Humidity sensor may be configured to act as or include a humidistat. A “humidistat”, for the purposes of this disclosure, is a humidity-triggered switch, often used to control another electronic device. Humidity sensor may use capacitance to measure relative humidity and include in itself, or as an external component, include a device to convert relative humidity measurements to absolute humidity measurements.

With continued reference to FIG. 1, sensor may include electrical sensors. Electrical sensors may be configured to measure voltage across a component, electrical current through a component, and resistance of a component. In one or more embodiments, sensor may include thermocouples, thermistors, thermometers, infrared sensors, resistance temperature detectors (RTDs), semiconductor based integrated circuits (ICs), a combination thereof, or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor, may be measured in Fahrenheit (° F.), Celsius (° C.), kelvin (K), Rankine (°R), or another scale alone or in combination. The temperature measured by sensors may comprise electrical signals, which are transmitted to their appropriate destination wireless or through a wired connection.

With continued reference to FIG. 1, sensor may include a plurality of sensing devices, such as, but not limited to, temperature sensors, humidity sensors, accelerometers, electrochemical sensors, gyroscopes, magnetometers, inertial measurement unit (IMU), pressure sensor, proximity sensor, displacement sensor, force sensor, vibration sensor, air detectors, hydrogen gas detectors, and the like. Sensor may be configured to detect a plurality of data, as discussed further below in this disclosure. A plurality of data may be detected from sensor.

With continued reference to FIG. 1, sensor may include a sensor suite which may include a plurality of sensors that may detect similar or unique phenomena. For example, in a non-limiting embodiment, a sensor suite may include a plurality of voltmeters or a mixture of voltmeters and thermocouples. System 100 may include a plurality of sensors in the form of individual sensors or a sensor suite working in tandem or individually. A sensor suite may include a plurality of independent sensors, as described in this disclosure, where any number of the described sensors may be used to detect any number of physical or electrical quantities associated with a charging connection. Independent sensors may include separate sensors measuring physical or electrical quantities that may be powered by and/or in communication with circuits independently, where each may signal sensor output to a control circuit. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained.

With continued reference to FIG. 1, sensor may include a sense board. A sense board may have at least a portion of a circuit board that includes one or more sensors configured to measure or detect a sensor input. In one or more embodiments, a sense board may include one or more circuits and/or circuit elements, including, for example, a printed circuit board component. A sense board may include, without limitation, a control circuit configured to perform and/or direct any actions performed by the sense board and/or any other component and/or element described in this disclosure. The control circuit may include any analog or digital control circuit, including without limitation a combinational and/or synchronous logic circuit, a processor, microprocessor, microcontroller, or the like.

With continued reference to FIG. 1, sensor is configured to transmit a sensor output signal representative of sensed information. As used in this disclosure, a “sensor signal” is a representation of a sensed information that sensor may generate. A sensor signal may include any signal form described in this disclosure, for example digital, analog, optical, electrical, fluidic, and the like. In some cases, a sensor, a circuit, and/or a controller may perform one or more signal processing steps on a signal. For instance, sensor, circuit, and/or controller may analyze, modify, and/or synthesize a signal in order to improve the signal, for instance by improving transmission, storage efficiency, or signal to noise ratio.

With continued reference to FIG. 1, exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 1, system includes a flow direction sensor 152. A “Flow direction sensor,” as described in this disclosure is a sensor configured to monitor the flow of resin mixture. For example and without limitation, flow direction sensor may be configured to monitor the flow rate of resin mixture, whether bubbles are present within resin mixture 128 and/or the like. In one or more embodiments, flow direction sensor 152 may include any sensor as described in this disclosure. In one or more embodiments, flow direction sensor 152 may be communicatively connected to main control unit 120. In one or more embodiments, main control unit 120 may be configured to monitor a flow behavior of resin mixture. In one or more embodiments, main control unit 120 may be configured to monitor a flow behavior of resin mixture from injection units 132 to mold cavity 116. In one or more embodiments, main control unit 120 may be configured to monitor a flow of resin mixture 128 at any position and/or time during a molding process using system 100. In one or more embodiments, main control unit 120 may monitor a flow behavior of resin mixture through the use of one or more flow direction sensors 152. In one or more embodiments, system 100 may include a plurality of flow direction sensors 152, wherein each flow direction sensor 152 may monitor a flow behavior of resin mixture 128 at a differing point within system 100. For example, and without limitation, one flow direction sensor 152 may be placed at or near inlet pipe in order to monitor a flow behavior of resin mixture 128 at inlet pipe.

With continued reference to FIG. 1, system 100 may include a plurality of flow direction sensors 152. In one or more embodiments, at least one flow direction sensor may be located within molding tool 104. In one or more embodiments, at least one flow direction sensor 152 may be located on venting hose 148. In one or more embodiments, at least one flow direction sensor may include a capacitive sensor. A “capacitive sensor,” as described in this disclosure is a sensor that detects changes in capacitance caused by the presence of absence of a material. In one or more embodiments, capacitive sensor may identify air bubbles within a transparent pipe in instances in which capacitance changes. In one or more embodiments, capacitive sensor may measure changes in capacitance wherein changes in capacitance may indicate the change or presence of a differing material. For example and without limitation, a decrease in capacitive may indicate that a fluid is present within the transparent material. In one or more embodiments, a decrease in capacitance may indicate that air bubbles have been sensed and are present, while an increase in capacitance may indicate the presence of a resin. In one or more embodiments, at least one flow direction sensor include an air bubble sensor located at least one resin outlet 144. An “air bubble sensor,” as described in this disclosure is a sensor configured to detect air bubbles in resin mixture. In one or more embodiments, air bubble sensor may include a capacitive sensor and/or optical sensor. In one or more embodiments, air bubble sensor may be configured to monitor a flow of excess resin mixture and identify a presence of air bubbles. In one or more embodiments, the presence of air bubbles within excess resin mixture may indicate that cavity 116 has not yet been completely filled. In one or more embodiments, flow direction sensor may be located on one or more venting hoses 148. In one or more embodiments, one or more venting hoses 148 may include a transparent material, such as for example, plastic silicone, glass and/or the like. In one or more embodiments, flow direction sensor 152 may be located on venting hose and configured to monitor a flow behavior of resin mixture 128 through transparent material. In one or more embodiments, flow direction sensors 152 such as air bubble sensor may be located outside of venting hose and configured to monitor a flow behavior within venting hose 148 through transparent material.

With continued reference to FIG. 1, at least one flow direction sensor 152 may be located within molding tool 104. In one or more embodiments, at least one flow direction sensor may be located outside of molding tool 104. In one or more embodiments, a location outside of molding tool may include but is not limited to, injection points 124, inlet pipes 136 at or near injection units 132 and/or the like. In one or more embodiments, a first flow direction sensor located within molding tool may be configured to identify an internal pressure within molding tool 104. In one or more embodiments, a second flow direction sensor located outside of molding tool 104 may be used to measure an injection pressure of resin mixture 128. In one or more embodiments, injection pressure may include a pressure at which resin mixture is injected into molding tool 104. In one or more embodiments, flow direction sensors may be located throughout system and used to measure pressure changes. For example, and without limitation, a flow direction sensor 152 located at or near resin outlet may be used to measure a pressure of resin exiting mold cavity. Similarly, a flow direction sensor 152 located at or near injection point may be used to measure a pressure of resin mixture during injection of resin mixture within mold cavity 116.

With continued reference to FIG. 1, main control unit 120 is configured to receive flow data 156 from plurality of flow direction sensors 152. “Flow data,” for the purposes of this disclosure refers to thew information collected by one or more flow direction sensors. For example, and without limitation, flow data 156 may include a flow rate of the resin, a pressure of the system at a given point, whether air bubbles are present and/or the like. In one or more embodiments, flow data 156 may include any information collected by any sensors as described in this disclosure. In one or more embodiments, flow data 156 may be used to monitor a flow behavior of resin mixture at any given point and/or time within system 100. In one or more embodiments, two or more flow direction sensors 152 may be used to calculate pressure differentials between two given points of system 100. For example and without limitation, two given points may include an injection point 124 and a resin outlet 144. In one or more embodiments flow data 156 may include a plurality of injection flow datums. “Injection flow datum,” as described in this disclosure refers to information received from a flow direction sensor. In one or more embodiment, flow data 156 may include a plurality of flow injection datums wherein each flow injection data is associated with a differing flow direction sensor 152. In one or more embodiments, main control unit 120 may be configured to compare one or more injection flow datums to identify pressure differentials, temperature differentials and/or the like.

With continued reference to FIG. 1, main control unit 120 may be configured to generate flow commands 140 as a function of flow data 156. In one or more embodiments, flow data may indicate the presence of air bubbles, wherein main control unit 120 may be configured to generate flow commands 140 to continue injection of resin mixture 128. In one or more embodiments, the absence of air bubbles at or near resin outlet 144 may indicate that cavity 116 no longer contains air bubbles and therefore supply of resin mixture is no longer needed. In one or more embodiments, main control unit 120 may be configured to generate flow commands 140 based off information received from sensors in any way as described in this disclosure. In one or more embodiments, a lack of pressure differential may indicate that resin is no longer needed, wherein main control unit 120 may generate flow commands 140 to cease supply of resin. In one or more embodiments, flow commands 140 may be transmitted to each injection unit 132 separately to control the supply of resin mixture 128 from each injection unit 132.

With continued reference to FIG. 1, main control unit may receive flow data 156 and transmit flow commands 140 as a function of comparison of injection flow datum. In one or more embodiments, a first flow command of the one or more flow commands 140 may be transmitted to a first injection unit of the more than one injection units 132 and a second flow command of the one or more flow commands may be transmitted to a second injection unit of the more than one injection units 132, wherein the first flow command differs from the second flow command. In one or more embodiments, main control unit 120 may be configured to receive flow data from one or more flow direction sensors 152, generate flow commands 140 and transmit flow commands to one or more injection units 132.

With continued reference to FIG. 1, in one or more embodiments, one or more flow direction sensors include at least a first sensor located within the molding tool and configured to measure an internal pressure within the molding tool and at least a second sensors located outside of the molding tool and configured to measure an injection pressure. In one or more embodiments, the main control unit is configured to transmit one or more flow commands to the more than one injection units as a function of the internal pressure and the injection pressure. In one or more embodiments, increasing injection pressure may indicate that the resin mixture is encountering higher resistance. This may be due to, but not limited to, uneven compaction and/or tight waves. In one or more embodiments, increased injection pressure may further indicate that the resin mixture may be thickening due to premature curing, temperature drops or improper resin formulation. In one or more embodiments, increasing resin injection pressure may further indicate blockages in the flow path, incomplete mold filling and/or the like. In one or more embodiments, decreasing injection pressure may indicate reduced mold resistance due to leaks, incorrect fiber placement, and/or lower than expected viscosity of the resin. In one or more embodiments, increasing outlet pressure such as for example, near resin outlet 144 may indicate clogging, incomplete air evacuation, an overfilled mold and/or the like. In one or more embodiments, simultaneous pressure increases may indicate overall flow resistance has increased, injection pressure has increased and/or the like. In one or more embodiments, increased pressure differentials between an inlet and/or outlet may indicate the presence of a leak. In one or more embodiments, main control unit 120 may use pressure and/or pressure differentials within flow data to monitor behavior of resin mixture 128 during a molding process. In one or more embodiments, main control unit may generate flow commands 140 to increase or decrease viscosity, flow rate and/or the like of resin mixture 128 to address pressure differentials. In one or more embodiments, flow commands 140 may include commands to increase viscosity, commands to increase or decrease flow rate and/or the like. In one or more embodiments, flow commands 140 may include any processes as described in this disclosure.

With continued reference to FIG. 1, one or more flow direction sensors may be configured to identify a position of one or more flow fronts of resin mixture 128. A “flow front,” as described in this disclosure refers to the leading edge of a resin mixture as it moves during an injection process. In one or more embodiments, the flow front may determine how uniformly and completely the fiber preform is impregnated with resin. In one or more embodiments, a consistent and unform flow front may indicate that all areas of the preform are wetted by the resin. In one or more embodiments, a proper flow front may push air and volatiles out through resin outlets 144. In one or more embodiments, one or more flow direction sensors 152 may be used to track resin flow in real time. In one or more embodiments, a flow direction sensor 152 may be associated with each injection unit 132 in order to monitor the flow of resin mixture 128 from each injection unit 132. In one or more embodiments, flow data may include the position of one or more flow fronts of resin mixture 128. In one or more embodiments, it may be desirable to have the same or similar positioning of multiple flow fronts. In one or more embodiments, main control unit 120 may increase pressure to speed up flow fronts, lower pressure to ensure uniform impregnation, increase temperature to improve viscosity, decrease temperature to increase viscosity and/or the like. In one or more embodiments, main control unit 120 may generate flow commands to ensure that flow fronts of resin mixtures 128 from differing injection units 132 are aligned.

With continued reference to FIG. 1, main control unit 120 may identify multiple flow fronts of resin mixtures 128 from differing injection units 132. In one or more embodiments, flow fronts may be identified based on flow data 156. In one or more embodiments, main control unit 120 may identify a convergence point of the flow fronts. A “convergence point,” for the purposes of this disclosure is a point at which multiple flow fronts meet. In one or more embodiments, convergence point of multiple flow fronts may include the location within mold cavity 116 where two or more advancing resin flow fronts meet during the injection process. In one or more embodiments, if air is not properly vented at the convergence point, then it may become trapped and lead to voids or bubbles. In one or more embodiments, improper merging of flow fronts may create area within too much of too little resin. In one or more embodiments, it may be advantageous to identify a convergence point to ensure proper resin flow within mold cavity 116. In one or more embodiments, main control unit 120 may be configured to alter convergence point based on changes in flow rates of resin mixture 128 from each injection unit 132. In one or more embodiments, main control unit 120 may be configured to generate flow commands to ensure that convergence points are controlled and meet at predetermined points. In one or more embodiments, at least one flow command may direct resin mixture to resin outlet 144 to ensure that convergence point is properly controlled. In one or more embodiments, main control unit 120 may use flow data 156 to synchronize timing of resin flow, balance injection pressures across all inlets, simulate resin inlets and/or the like. In one or more embodiments, flow fronts and/or convergence points may be identified in any way as described in this disclosure. In one or more embodiments, main control unit may use any calculation and/or process as described in this disclosure to generate flow commands and control one or more injection units 132. In one or more embodiments, main control unit may control resin flow of resin mixture in any way as described in this disclosure.

With continued reference to FIG. 1, main control unit 120 may be configured to receive flow data 156. In one or more embodiments, main control unit 120 may be configured to identify critical data as a function of flow data 156. “Critical data,” for the purposes of this disclosure refers to information indicating a failure in one or more processes carried out by system. For example, and without limitation, critical data may indicate a blockage, a leak and/or the like. In one or more embodiments, critical data may indicate that resin mixture 128 has hardened within an inlet pipe and as a result, resin mixture may not ensure mold cavity 116. In one or more embodiments, main control unit may identify critical data through pressure differentials, the lack of resin mixtures within a given inlet and/ort he like. In one or more embodiments, critical data may further indicate that resin mixtures being injected contain air bubbles and will therefore create a faulty molded part. In one or more embodiments, air bubble sensors on inlet pipe 136 may be used to identify air bubbles and therefore identify critical data. In one or more embodiments, critical data may include any information that may be pertinent to an individual during a molding process. In one or more embodiments, critical data may include any critical data as described in this disclosure. In one or more embodiments, critical data may be transmitted and/or displayed on a display device such as any display device as described in this disclosure.

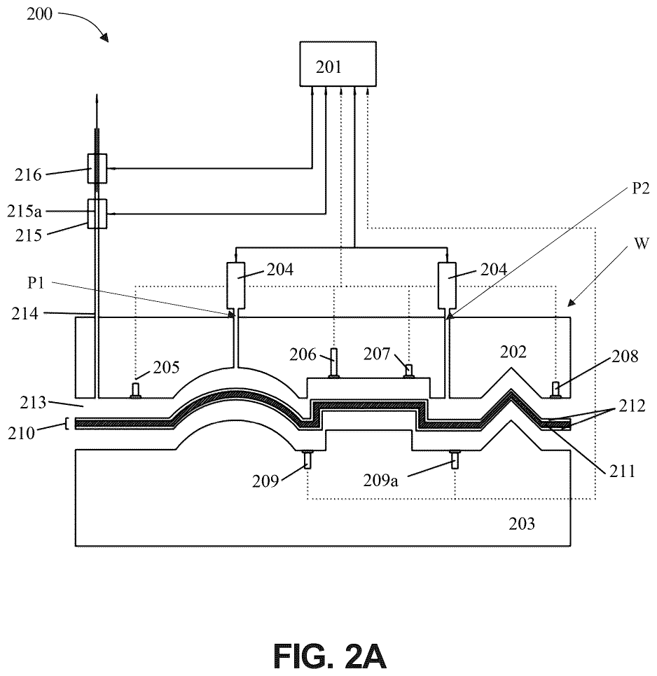

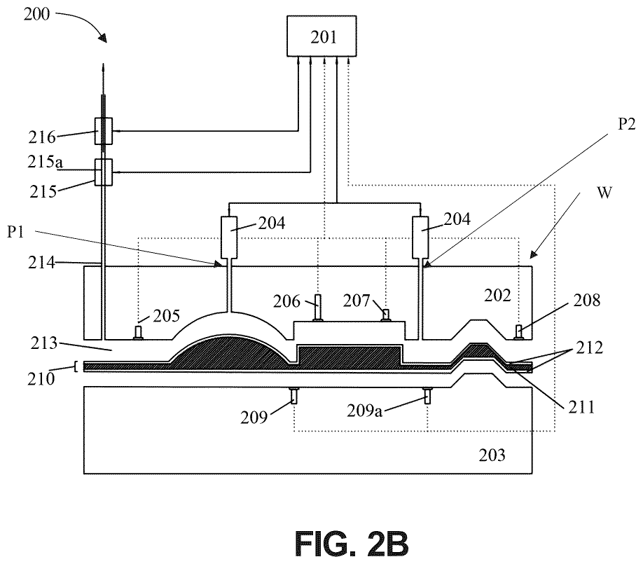

Referring now to FIGS. 2A-B, an exemplary embodiment of a representation of a system 200 for a closeable molding tool W is described. In one or more embodiments, closable molding tool W may be used to manufacture composite parts from a semi-finished product with a uniform thickness (as illustrated in FIG. 2A) or a different foam core thickness (As illustrated in FIG. 2B). In one or more embodiments, system 200 may include sensors used for real-time monitoring during the multi-injection RTM process, including sensors for pressure, temperature, flow detection and curing. The number of sensors, resin outlets and resin sealing units may be adjusted depending on the process requirements and the size of the mold. This flexibility may ensure optimal performance and precise control during the manufacturing process.

With continued reference to FIGS. 2A-B, system 200 may include a main control device 201. In one or more embodiments, main control device 201 may include a computing device.

With continued reference to FIGS. 2A-B, closeable molding tool W includes an upper mold half 202 and a lower mold half 203. In one or more embodiments, upper mold half 202 and lower mold half 203 may be in an open position and/or in a closed position. In one or more embodiments, in an open position upper mold half 202 and lower mold half 203 may be separated from one another wherein a carbon fiber material such as a fabric layer 212 may be placed between upper mold half 202 and lower mold half 203.

With continued reference to FIGS. 2A-B, in one or more embodiments, at least two injection units 4d, 4b, spaced apart from one another, lead to the mold cavity 213 between the two tool halves, whereby two injection points P1 and P2 are present, which lead to the mold cavity 213 via unmarked channels. In one or more embodiments, more than two injection units and thus more than two injection points can be provided. Furthermore, it is possible that in one or more embodiments, more than one injection point leads from one or more injection units to the molding tool.

With continued reference to FIGS. 2A-B, at least one temperature sensor 205 may be integrated into the tool, here into the upper mold half 202. Furthermore, at least one pressure sensor 206, at least one inclination sensor 207 and at least one distance sensor 208 may be integrated here into the upper mold half 202. The lower mold half 203 may have at least one flow sensor 209 and at least one sensor for monitoring the curing 209a.

With continued reference to FIGS. 2A-B, all the sensors shown as examples in the molding tool W can be integrated in the upper and/or lower mold halves 202, 203.

With continued reference to FIGS. 2A-B, a semi-finished product made of fiber material, a preform 210, may be inserted between the two mold halves 202, 203, which for example, and without limitation, has a core material 211 and outer fabric layers 212, whereby the preform 210 may be located in the mold cavity 213 between the mold halves 202, 203.

With continued reference to FIGS. 2A-B, a resin outlet 214 may be provided here in the upper mold half 202 (whereby there may also be several resin outlets), which leads via a preferably transparent area 15a to a capacitive sensor 215 and to a resin closing unit 216. The injection units 204, the sensors in the form of the temperature sensor(s) 205, pressure sensor(s) 206, inclination sensor(s) 207, distance sensor(s) 208, flow sensor(s) 209, capacitive sensor(s) and the resin closing unit 216 may all be connected to the main control device 201.

With continued reference to FIGS. 2A-B, mold cavities 213 formed as illustrated in FIGS. 2A-B may be designed according to the component shape to be produced. In one or more embodiments, mold cavities 213 may differ for each manufacturing process and/or for each differing component shape that is to be produced. For example, and without limitation mold cavities 213 may differ when producing an outer mold line of an aircraft in comparison to an interior structure of an aircraft.

Referring now specifically to FIG. 2A, in one or more embodiments, the semi-finished product in the form of the preform 210 may have a uniform thickness. Additionally or alternatively, and referring now to FIG. 2B, some non-designated areas of the preform 210 may be thicker and others may be flatter.

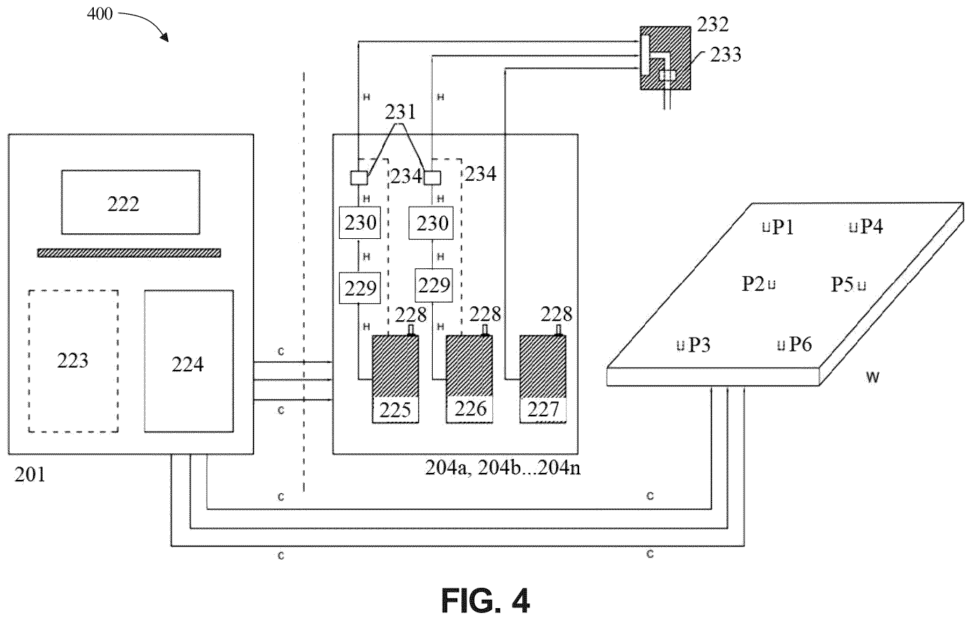

Referring back to FIGS. 2A-B, the main control device 201 and the injection units 204 may be made up two different and/or separate components: the RTM control device in the form of the main control device 201 (control unit) and the RTM injection units in the form of the injection units 204a-n (as shown in FIG. 4).

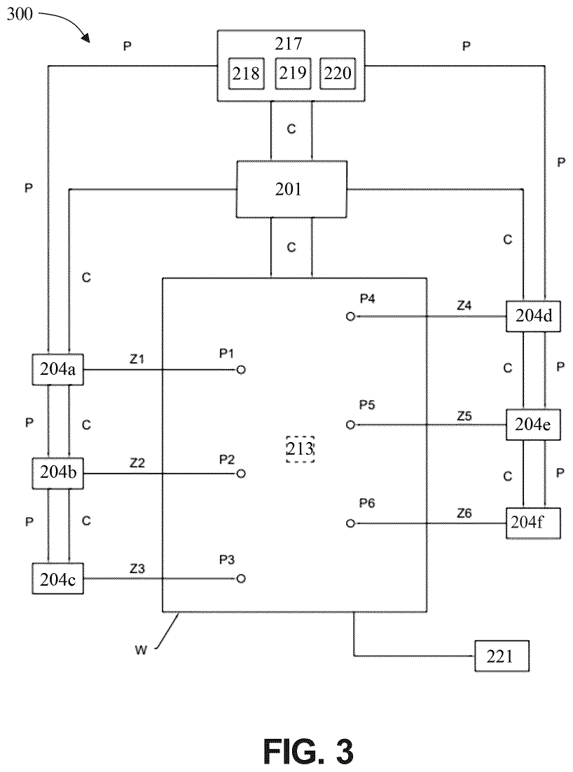

Referring concurrently to FIGS. 2A-B and FIG. 3, in one or more embodiments, to manufacture a component using the system 200 and method according to the invention, a preform 210 (as shown in FIGS. 2A-B) may be placed in the mold cavity of the molding tool W and the tool is closed. The sensors of the molding tool W may be connected to the main control device 201 via cables and the injection units 204a, 204b . . . 204n may also be coupled to the main control device 201. Furthermore, the injection units 204a, 204b . . . 204n may be connected to the corresponding injection points P1, P2 . . . Pn on the molding tool W. The resin outlets may be connected to the molding tool and the resin closing units may be connected to the main control device 201. In one or more embodiments, systems described herein may include multiple injection units 204a-f, wherein each injection unit 204 of the multiple injection units 204a-f may be configured to supply resin mixture.

With continued reference to FIGS. 2A-B and FIG. 3, for the injection process, the resin outlets may be connected to a vacuum system and the injection of the resin +hardener mixture into the mold is started in the form of individual injection units, all of which are controlled and operated by the main control device 201. This saturates the preform with the resin-hardener mixture.

With continued reference to FIGS. 2A-B and FIG. 3, based on the sensor feedback at the resin outlets, the resin closing units close the outlets as soon as the mold/mold cavity is filled and the resin-hardener mixture escapes from one or more resin outlets. The curing reaction may be initiated by increasing the temperature of the molding tool. The temperature may be maintained until the curing process is complete. After the RTM process and curing are complete, all connections of the sensors of molding tool W are disconnected from the main control device 201. Then the injection units 204a, 204b . . . 204n are disconnected from the injection points P1, P2 . . . Pn. The molding tool W is then opened, and the finished part can be removed. The overall modular design with the flexible number of injection units 204a, 204b . . . 204n and injection points P1, P2 . . . Pn allows for greater flexibility and adaptability in the production of large-sized components in the RTM process-for the first time according to the invention with several injection points. The number of required injection units 204 and thus of the injection points can be selected by the component manufacturer according to the production requirements.

With continued reference to FIGS. 2A-B and FIG. 3, in contrast to injection systems with a single injection point, the system 200 according to the invention works with several injection units 4a, 4b etc. and several injection points P1, P2 etc., with each injection point P1, P1 etc. preferably being controlled by its own RTM injection device in the form of the injection unit 204a, 2044b etc.

With continued reference to FIGS. 2A-B and FIG. 3, the control of the various injection units 204a, 204b etc. is carried out by the main control device 201, which processes the information from all the injection units 204a, 204b etc. connected to the molding tool. This means that the parameters at each injection point Pa, P2 etc. can be controlled separately, but the information from other injection units and the molding tool W can be taken into account in the control process. Therefore, the parameters at each injection point Pa, P2, etc. can be controlled separately, depending on the real-time feedback of the resin flow (measured with the flow detection sensors 209) and/or the injection pressure (measured with the pressure sensors 206) of other injection units 204a, 204b, . . . , 204n and the real-time sensor response of the other sensors integrated into the mold (see description above).

With continued reference to FIGS. 2A-B and FIG. 3, the creation of multiple injection points P2, P2 . . . Pn may enable a faster mold filling process, resulting in short cycle times and better part quality. Furthermore, this method may allow for the realization of long flow paths and thus the production of large-sized components in the RTM process. The integration of additional sensor technology may enable system 200 to achieve an unprecedented level of automation and ensures ideal conditions by continuously monitoring resin flow, temperature and pressure throughout the entire process.

With continued reference to FIGS. 2A-B and FIG. 3, the networked structure enables coordinated and synchronized operation of the injection units 204a, 204b . . . 204n during the RTM process. The main control device 201 is a control unit and acts as a kind of brain, issuing commands to the injection units 204a, 204b . . . 204n and coordinating the injection process. This invention significantly improves the precision of resin distribution and overall control during the manufacturing process.

FIG. 3 shows a representation 300 of the components for implementing the multiple injection RTM process and FIG. 4 shows a schematic 400 of the main control device 201 and one of the injection units 204 for the multiple injection RTM system.

Referring now specifically to FIG. 4, the main control device 201 (control unit) allows the operator access to all components connected to the system. The main components of the main control device 201 include a user interface with a graphical user interface, all power circuits, sensor indicators and control switches. The sensor indicators are used to display the status and/or performance of the sensors. Furthermore, secondary parts in the form of identification tags and intelligent LED lights are used to display the process steps of the RTM process. These components of main control device 201 are not shown. The injection devices in the form of the six injection units 204a-f contain a resin container 225, hardener container 226 and cleaning liquid container 227, metering pumps 230, mixing heads 232, hoses H and an automatic cleaning unit for cleaning the hoses and the mixing head 232.

With continued reference to FIG. 4, the six injection units 204a-f may include the necessary hoses H, resin and hardener pumps 229, an integrated heating system for heating the pipes and the tank, vacuum pumps, air bubble detection sensors, temperature sensors, pressure sensors and flow sensors, which are also not shown.

Referring back to FIG. 3, an automatic refilling station 217 is also provided, which is connected to the injection units 204a-f. The automatic refilling station 217 has storage containers. The storage containers include a resin storage container 218 containing a resin, a hardener storage container 219 container a hardener and/or a cleaning liquid storage container 220 containing a cleaning liquid. At least one excess storage container 221 may be provided, for example for resin leaking out of the mold.

With continued reference to FIG. 3, from the refilling station 217, indicated lines P lead to the injection units 204a-f, which in turn communicate with the main control device 201 by means of cables C. The injection units 204a-f are connected via lines Z1 to Z6 to injection points P1 to P6 on the molding tool W, which lead to the mold cavity 213. The secondary components include pumps, valves and level sensors, as well as control systems for the realization of the refilling processes to the injection units, which are not shown.

Referring back to FIGS. 2A-B, the molding tool W may include a mechanical, hydraulic, pneumatic or magnetic clamping system, depending on the clamping force required to close the mold. The clamping system may be used to close the upper mold half 202 and the lower mold half 203 with the required clamping force to withstand the pressure when injecting the resin/hardener mixture. additionally or alternatively, temperature sensors 205, pressure sensors 206, inclination sensors 207, distance sensors 207 and flow sensors 209 are integrated into the molding tool. The main control device 201 may continuously monitor the injection process (using flow sensor(s), temperature sensor(s), pressure sensor(s)) and the curing process (e.g. electrical tool sensors, ultrasonic sensors, optical sensors or viscosity sensors). The main control device 201 may be used to control the process parameters of all injection units 204a, 204b . . . 204n.

With continued reference to FIGS. 2A-B, the molding tool W may feature one or more non-represented identification tags, an ejector system for ejecting the finished component and a curing monitoring system. Ultrasonic sensors, for example, may be used to monitor the curing process.

Referring back to FIG. 3, the new process and the apparatus were developed specifically for the requirements of manufacturing large-format fiber composite components. Its characteristic feature is the integration of several injection points P1 . . . Pn, which offers it several advantages over single-point injection systems. These advantages are reflected in better resin distribution, faster production cycles and greater accuracy throughout the entire injection process, leading to an important change in composite material manufacturing technology. For example, the system includes a total of four different components: the main control device 201, the injection units 204a-n, each of which is connected to at least one injection point P1 to Pn, the automatic refilling station 217 and the molding tool W.

With continued reference to FIG. 3, the main control device 201 may include a central processing unit, interface panels, software for process control and communication modules. The main control device 201 may also include microprocessors or microcontrollers for processing commands and data; interface modules for communicating with sensors and injection units; storage units for storing commands, process parameters and data logs; control algorithms for coordinating the movements of the injection units and managing the injection process.

With continued reference to FIG. 3, system 100 may have a robust communication network, such as Ethernet or CAN-Bus, to facilitate the exchange of data between the injection units and the control device. The data exchange of the communication network can be wired or wireless. The main control device 201 is programmed to recognize and communicate with each injection unit 204a-n in the system, whereby the roles and responsibilities of each injection unit 204a-n are defined based on the specific requirements of the RTM process using multiple injection technology. The main control device 201 can define sequences for resin injection, taking into account factors such as tool geometry and resin flow dynamics. Synchronization signals or time-based triggers are used to coordinate the movements and actions of each injection unit 204a-n. Each injection unit 204a-n may have integrated sensors and monitoring devices to determine the injection pressure and flow rate, in order to provide real-time feedback on their status and performance. The changes to the process parameters of a particular injection unit can then be made based on the measured parameters such as injection pressure and/or the flow rate. Additionally or alternatively, the changes to the process parameters of a particular injection unit may be made based on the real-time feedback of the flow rate and/or injection pressure from other injection units 204a, 204b, . . . ,204n and the real-time sensor response from the tool. The solution according to the invention thus provides a multiple injection system with sequential injection and/or variable pressure injection.

With continued reference to FIG. 3, an injection unit 204a-n can be operated at one or two, or possibly also further, injection points, depending on the customer's requirements and/or depending on the process requirements and/or the complex shapes and geometries of the parts. Each injection unit may contain a separate mixing head for mixing resin and hardener. The mixing head can be equipped with temperature sensors and/or pressure sensors (as shown in FIG. 4) to measure the temperature and pressure of the resin system at the time of the injection process. In addition, sensors can be integrated to measure the mixing ratio of the mixed components. (e.g. with density measurements or spectroscopy or by detecting the refractive index) If the mixing ratio of individual components deviates from the desired mixing ratio, the sensor sends a signal to the main control device 201. The main control device 201 then sends a signal to the respective injection unit(s) to make changes to the flow volumes of the respective components and to correct the mixing ratios. The mixing head also has a cleaning option to clean the mixing head with cleaning fluid after the injection process is complete. If the stored values for the mixing ratio are exceeded or not reached, the control system adjusts the respective delivery rate by means of a correction calculation.

With continued reference to FIG. 3, sequential injection may include a process in which the resin system is sequentially injected into the mold cavity 213. Initially, the first injection unit 4a initiates the resin injection. As soon as the second injection unit 4b detects a resin flow, it is activated to continue the injection process while the first injection unit 4a stops operating. This sequential injection pattern continues until the entire mold is sequentially filled with resin via injection units 204a-n. In contrast, with the variable pressure injection method, resin is injected from all injection units 204a-n simultaneously. When the resin flow is detected, the flow detection sensors 209 send feedback to the main control device 201. The main control device 201 then adjusts the injection pressure of each individual injection unit 204a-n. This dynamic adaptation is important to prevent air bubbles entrapment, especially when flow fronts from multiple injection points P1 to Pn converge in the mold. By regulating the injection pressure in real time, the variable pressure injection method ensures uniform resin distribution and minimizes defects, ultimately improving the quality of the composite material part produced.

With continued reference to FIG. 3, the main control device 201 commands the injection units 204a-n based on process requirements and the measurement data from the sensors. Real-time feedback data from all sensors integrated in the mold are supplied to the main control device. This main control device 201 controls the operation of the injection units 204a-n and coordinates their actions for optimal performance. The automation of the process sequence occurs automatically during the injection process. When the operator determines that the injection routines of all multiple injectors are appropriate for the production of the particular part, the operator can initiate the injection process. If the operator wishes to make changes to the injection routine parameters, the operator can adjust the parameters as required prior to initiating the injection process. This process of parameter adjustment ensures proper resin flow during the production of composite material parts. However, if during the injection process the resin flow does not work according to the simulated data (stored in the system) or if dry stops are observed in the mold during the process (this feedback is received from the sensor technology implemented in the mold to detect air bubbles at the resin outlet and/or to detect resin flow in the mold), some process parameters such as the injection pressure of all injection units can be changed individually. Modifications can be saved in the main control device 201 for future applications. This gives the operator partial control if he detects an error during the injection process. Therefore, the injection process is preferably controlled fully automatically or, if necessary, also partially manually (if required) in order to ensure proper resin impregnation of the fabrics based on feedback from the sensor system in the form of real-time feedback data from all sensors integrated into the mold. This new approach will improve processing capabilities for faster response times and better control over the injection process.

With continued reference to FIG. 3, a refill station 217, equipped with large storage containers-a resin storage container 218 with resin, a hardener storage container 219 with hardener and a cleaning liquid storage container 220 with cleaning liquid, ensures a constant supply of the resin containers 225, hardener containers 226 and cleaning liquid containers 227 of the individual injection units 204a, 204b, . . . 204n. The resin storage containers 218, hardener storage containers 219 and/or cleaning liquid storage containers 220, can be equipped with an integrated heating system if preheating of resin and hardener components is required. The resin storage containers 218, hardener storage containers 219 and/or cleaning liquid storage containers 220 may be referred to throughout this disclosure collectively and/or individually as “containers of the refill station”. The refill station 217 is connected to the injection units 204a, 204b, . . . 204n via hoses or heatable hoses and performs a refill operation when the level sensor(s) in the smaller containers of the injection units 204a, 204b, . . . 204n signal to the main control device 201 that the required level is no longer reached. This refilling process can be controlled and operated via the main control device 201 or independently of each other. Water is used as the preferred heating/cooling medium for heating/cooling the two pressure vessels of the resin storage containers 218, the hardener storage containers 219 and the hoses not shown. All containers of the refill station and also the containers of the injection units 204a, 204b, . . . 204n, which are not shown, are equipped with an agitator. The filling level of the containers is preferably measured by capacitive sensors, which ensures that the required amount of material is present in the storage container before the injection process is continued. The material is constantly de-aerated by a thin film degassing system (not shown). These pre-supply pumps also ensure a constant material supply to the metering pumps, which are driven by servo motors and designed as gear pumps. The installed gear pumps can be selected by the customer based on their drive power and mixing ratio range. The mixing ratio of resin and hardener can be specified in advance for the component or can also be determined and adjusted during the injection process and also visualized in the main control device 201. If the values for the mixing ratio fall below or exceed the stored values, the main control device 201 can readjust the mixing ratio and/or the respective delivery rate via a correction factor.

With continued reference to FIG. 3, according to one or more embodiments, various embodiments of the subject disclosure may include air bubble detection sensors that measure the presence of air bubbles in the hoses before they are fed to tool W. The temperatures and pressures are constantly monitored both in the containers of the refill station and possibly in the non-displayed containers of the injection units 4a, 4b, . . . 4n and in the non-designated recirculation and dosing lines. The components of the injection material are mixed in the static mixing head of the injection units and conveyed to the molding tool W via a heatable hose. The flow volume of each component is monitored by flow sensors and a current mixing ratio is calculated by the main control device 201. This ensures a constant flow and the material-specific mixing ratio.

Referring back to FIG. 4, each injection unit 204a-n can be operated with up to three component versions of a mixing head 232, depending on the production requirements and processing parameters. Each injection unit is assigned a mixing head 232. The mixing head 232 is equipped with several openings or channels through which various resin components can be introduced. These components may include the base resin (one or more), hardener (one or more) and other additives. The design with regard to the mixing ratio is only used to optimize the speeds, so that a wide range of delivery rates is possible. Thus, it does not matter whether the system is to be designed for a mixing ratio of 100:201 or 100:100. The cleaning of the mixing head with air and cleaning liquid, e.g. acetone, including the hoses, would preferably be carried out at the same time.

Referring back to FIGS. 2A-B, to control the injection process, molding tools W with resin outlets 214, temperature sensors 205 and pressure sensors 206 (the number of which depends on the size of the tool) can be connected to the main control device 201. From a surface of the preform 210 and thus of the component to be manufactured, preferably two or more resin outlets 214 are provided at points on the molding tool W that are distant from each other. The monitoring of pressure, temperature and mass flow is combined with special resin outlets 214 in the molding tool W. These consist of a capacitive measuring unit with one or more capacitive sensors 215 for resin flow detection and a pneumatically controlled pinch valve (not shown). These capacitive sensors 215 can also be used to detect the quantity or size of air bubbles in the outlet hose.

With continued reference to FIGS. 2A-B, in the subsequent process automation, this characteristic value is used by the control logic to automatically open and close the resin outlets 214 by determining the ratio between the capacitance change (feedback from the sensors) and the volume of air bubbles present in the resin. This feedback is then fed back to the control unit to change/adjust the process parameters of the individual injection units accordingly. The sensors are placed in the mold to detect the resin flow in the mold during the injection process. Furthermore, the mold has various types of sensors (distance sensors, inclination sensors), e.g. to detect the distance between two mold halves, to ensure that the mold is properly closed before the injection process begins, and also to detect the tool angle position. Typically, a not shown electrical heating system (or other system, depending on the application) is used for heating/cooling the mold. This heating/cooling system can be used as a separate additional component and is controlled and operated separately or by the main control device 201 (depending on the size of the mold). The tool also features real-time monitoring of the curing process. To do this, it has one or more integrated sensors to monitor the curing process. These can be dielectric sensor(s), ultrasonic sensor(s), optical sensor(s) or viscosity sensor(s). These provide the information about viscosity and/or Tg value (Glass Transition Temperature) and/or degree of cure in real time to the main control device 201. Ultrasonic sensors, for example, which are not shown, are then installed in the mold to provide information about the completion of the curing process. Based on this information, the main control device 201 can optimize the process parameters to obtain high-quality composite material parts for future applications.

With continued reference to FIGS. 2A-B, all important parameters such as flow rates, mixing ratio, resin discharge, flushing operations, temperature of the medium, temperature of the tool, air bubble properties, injection pressure of the medium and tool internal pressure are controlled and documented by the main control device 201. The necessary changes to the aforementioned parameters are made on the basis of the real-time feedback provided by the sensors/sensor systems. Once a process routine has been established, it can be repeated for the mass production of the same component. Since this is a completely closed system, oxidation or crystallization of the resin system is reduced. For resin systems that react very strongly to the ambient air, it is possible to reduce the container overpressure with a nitrogen bottle instead of compressed air. The system is equipped with overload protection for the pumps (not shown), the mixing head and the hose lines (not shown). This automatically prevents material from being conveyed when the mixing head is closed.

Referring Back to FIG. 4, FIG. 4 schematically shows the connection between the main control device 201, an exemplary injection unit 204a and the molding tool W. The main control device 201 has at least one monitor 222 (PC) as well as electronic circuits and control panels 223 (of the control) and sensor displays 224 and control panels 223. The injection unit 204a shown here as an example (as well as the other injection units 204b . . . 204n) has a resin container 225 (component 1, wherein component 1 refers to a resin as such as any resin as described in this disclosure), a hardener container 226 (component 2, wherein component 2 includes a curing agent or hardener such as any curing agent or hardener as described in this disclosure) and a cleaning liquid container 227 for cleaning liquid. In one or more embodiments, resin container 225, hardener container and/or cleaning liquid container 227 may be referred to individually and/or collectively as “injection unit containers.” Each small container injection unit container has a level sensor 228. For the injection process, resin and hardener are conveyed from the injection unit containers by means of pumps 229 (backing pumps or gear pumps) and metering pumps 230 via heated hoses H, in which flow sensors 231 are integrated, to a mixing head 232. One or more sensors 233 are arranged in the mixing head 232, in particular at least one temperature sensor and/or at least one pressure sensor and/or at least one density/ultrasonic/optical sensor. In front of the mixing head, a bypass system 234 leads from the hoses H back to the injection unit containers. In the mixing head 232, the resin and hardener components are mixed and conveyed via a supply line Z1 to the injection point P1 of the molding tool W indicated and injected into the mold cavity with the preform 210 located therein. Further mixing heads of identical injection units 204b-f are also connected to the injection points P2 to P6 of the molding tool W and also inject the resin-hardener mixture into the molding tool W via these.

With continued reference to FIG. 4, The main control device 201 is coupled to the injection units 204a-f and the tool via cable C. The signals of all sensors of the tool and of the sensors of the injection units 204a-f, including the sensors of the mixing head 232, are transmitted to the main control device 201 preferably in real time. The main control device 201 controls the injection process of the injection units 4b to 4f in dependence thereon. A further small operating station, not shown, can advantageously be attached to the molding tool, which can be used for operating the opening and closing of the molding tool W and the ejection of the finished part, which is also not shown, and which also contains various smart light displays for the various phases of the RTM process, such as the process status of the RTM process, errors during the process, etc. This small operating station is only used for operation before and after starting the RTM process. Once the process has started, all functions are controlled via the main control device 201 until the RTM process is complete. After the process has been completed, the resin-impregnated and hardened finished part is removed with the help of a pneumatic or hydraulic ejector system (not shown) that is built into the mold.

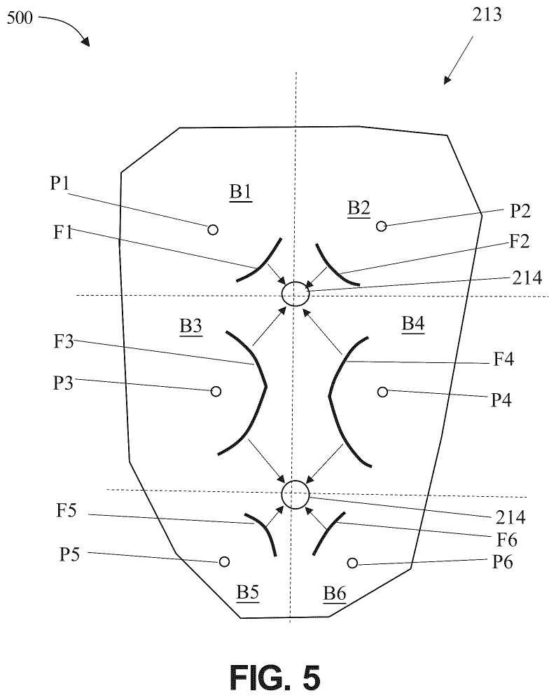

Referring now to FIG. 5, An exemplary embodiment of a simplified representation 500 of the flow fronts F1 to F6 of the injected resin mixture, which was injected into the molding tool via six injection points P1 to P6 is described. The perimeter of the mold cavity 213 is schematically indicated, which is divided into six areas B1 to B6, see dashed lines. The division of the areas B1 to B6 is carried out according to the surface division of the preform and the component to be manufactured from it. An injection point P1, P2 . . . P6 leads to each area B1 to B6, through which resin mixture was injected into the mold cavity 213.

With continued reference to FIG. 5, the flow fronts F1, F2 and F5, F6 are shown to be closer to a resin outlet 214 than the flow fronts F3, F4, indicated by the shorter and longer arrows. At the same flow rate, the flow fronts F1, F2 and F5, F6 would thus reach the resin outlets 214 first and emerge from them. Unfortunately, air bubbles from the resin mixture in areas B3 and B4 cannot escape or only to an insufficient extent. Since all flow fronts F1 to F6 are detected by sensors in the tool, it is now possible to influence them in such a way that the flow fronts arrive at the resin outlets 214 at the same time. This is realized by reducing the injection pressure in the areas (here B1, B2, B5, B6) where the flow fronts (here F1, F2, F5, F6) are closer to the resin outlets 214 and/or that the injection pressure in the areas (here B3, B4) in which the flow fronts (here F3, F4) are further away from the resin outlets 214 is increased. Alternatively or additionally, the injected volume of resin mixture at the injection points (here P1, P2, P5, P6) can be reduced and/or the injected volume at the injection points (here P3, P3) can be increased. It is also possible to provide a further resin outlet 214 between the two areas B3 and B4, from which the resin mixture supplied via the flow fronts F3 and F4 can escape.

In order to meet the demands of digitalization in industrial production, the sensors of the largely communicate with “IO-Link” (IO-Link is the first globally standardized IO technology (IEC 61131-209) for communicating with sensors and actuators). This system enables the bidirectional communication of values, switching states, device data and status information “on demand”. The solution according to the invention has created a new, efficient and complex system for an RTM process with multiple injection technology (RTM), with which even very large components can be manufactured in a short time and in high quality.

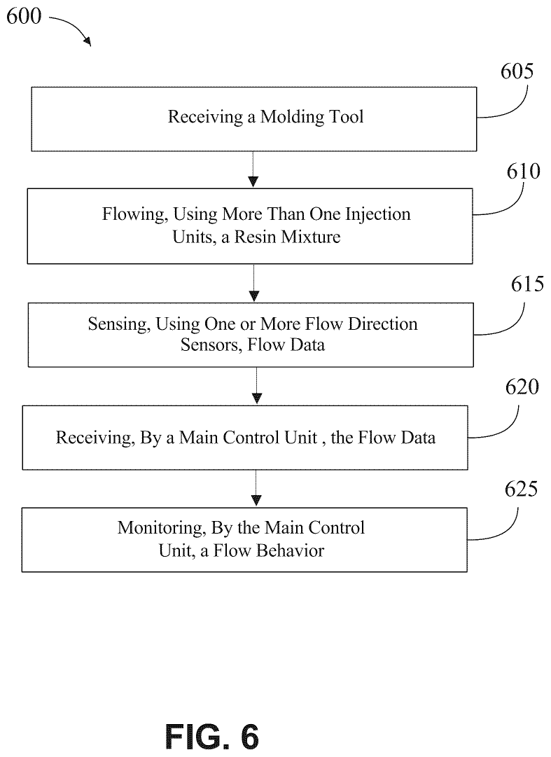

Referring now to FIG. 6, an exemplary method 600 for carrying out an RTM (Resin Transfer Molding) process is described. At step, 605 method 600 includes receiving a molding tool including an upper mold half and a lower mold half, wherein the upper mold half and lower mold half form a mold cavity configured for placement of a preform. This may be implemented with reference to FIGS. 1-5 and without limitation.

With continued reference to FIG. 6, at step 610 method 600 includes flowing, using more than one injection units, a resin mixture into the mold cavity, wherein the more than one injection units are fluidly connected to the molding tool through more than one injection points. This may be implemented with reference to FIGS. 1-5 and without limitation.

With continued reference to FIG. 6, at step 615 method 600 includes sensing, using one or more flow direction sensors, flow data of the resin mixture. This may be implemented with reference to FIGS. 1-5 and without limitation.

With continued reference to FIG. 6, at step 620 method 600 includes receiving, by a main control unit communicatively connected to the one or more flow direction sensors, the flow data. This may be implemented with reference to FIGS. 1-5 and without limitation.

With continued reference to FIG. 6, at step 625 method 600 includes monitoring, by the main control unit, a flow behavior of the resin mixture from the more than one injection points to the mold cavity using the flow data This may be implemented with reference to FIGS. 1-5 and without limitation.

With continued reference to FIG. 6, in one or more embodiments, the molding tool includes more than one resin outlets fluidly connecting one or more venting hoses to the molding tool, wherein the one or more venting hoses are configured to expel an excess of the resin mixture within the mold cavity and at least a second sensor of the one or more flow direction sensors is located on at least one venting hose of the one or more venting hoses, wherein the at least a second sensor includes a capacitive sensor. In one or more embodiments, the main control unit is communicatively connected to the more than one injection units and monitoring, by the main control unit, the flow behavior of the resin mixture includes controlling, by the main control unit, a flow of the resin mixture withing the more than one injection units. In one or more embodiments, monitoring, by the main control unit, the flow behavior of the resin mixture includes transmitting, by the main control unit, one or more flow commands to the more than one injection units as a function of the flow data. In one or more embodiments, receiving, by the main control unit communicatively connected to the one or more flow direction sensors, the flow data includes identifying critical data within the flow data. In one or more embodiments, method 600 further includes transmitting, by the main control unit, the critical data to a display device. In one or more embodiments, the flow data includes one or more injection flow datums. In one or more embodiments, monitoring, by the main control unit, the flow behavior of the resin mixture includes comparing the one or more injection flow datums to one or more predefined targets and transmitting the one or more flow commands to the more than one injection units as a function of the comparison. In one or more embodiments, a first flow command of the one or more flow commands is transmitted to a first injection unit of the more than one injection units and a second flow command of the one or more flow commands is transmitted to a second injection unit of the more than one injection units, wherein the first flow command differs from the second flow command. In one or more embodiments, the one or more flow direction sensors are configured to identify a position of one or more flow fronts of the resin mixture. In one or more embodiments, receiving, by the main control unit communicatively connected to the one or more flow direction sensors, the flow data includes identifying a convergence point of the one or more flow fronts as a function of the flow data. In one or more embodiments, monitoring, by the main control unit, the flow behavior of the resin mixture includes transmitting one or more flow commands to the more than one injection units as a function of the identified convergence point, wherein the one or more flow commands are configured to direct the resin mixture to one more than one resin outlets on the molding tool. In one or more embodiments, at least one flow command of the one or more flow commands include an injection pressure. In one or more embodiments, at least one flow command of the one or more flow commands include an injection volume. In one or more embodiments, at least one sensor of the one or more flow direction sensors includes an air bubble sensor located at at least one resin outlet of more than one resin outlets located on the molding tool and wherein the air bubble sensor is configured to detect air bubbles in the resin mixture. In one or more embodiments, the one or more flow direction sensors include at least a first sensor located within the molding tool and configured to measure an internal pressure within the molding tool and at least a second sensors located outside of the molding tool and configured to measure an injection pressure. In one or more embodiments, monitoring, by the main control unit, the flow behavior of the resin mixture includes transmitting one or more flow commands to the more than one injection units as a function of the internal pressure and the injection pressure.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

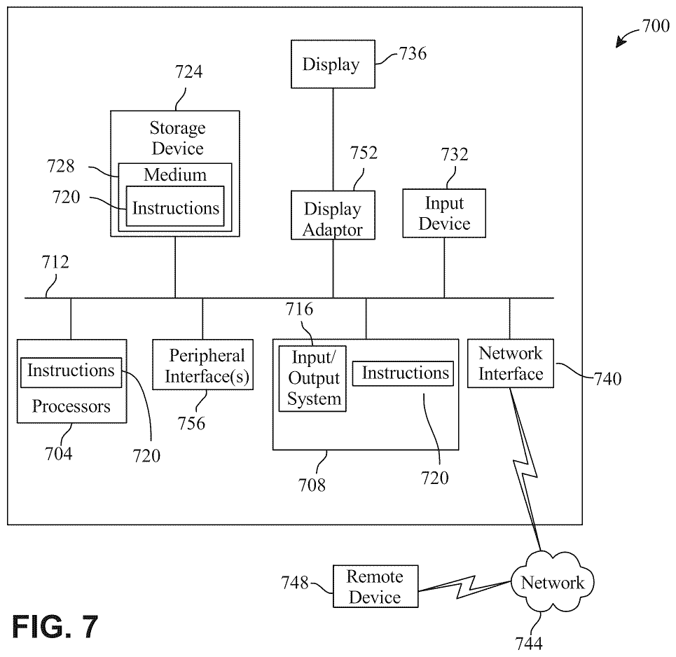

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display 736. Examples of a display device include, but are not limited to, a liquid crystal display (LCD), a cathode ray tube (CRT), a plasma display, a light emitting diode (LED) display, and any combinations thereof. Display adapter 752 and display 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system for carrying out an RTM (Resin Transfer Molding) process, the system comprising:
a molding tool comprising an upper mold half and a lower mold half, wherein the upper mold half and lower mold half form a mold cavity configured for placement of a preform;
a main control unit;
more than one injection units configured to supply a resin mixture into the mold cavity;
more than one injection points fluidly connecting the more than one injection units to the molding tool;
one or more venting hoses configured to expel an excess of the resin mixture within the mold cavity;
more than one resin outlets fluidly connecting the one or more venting hoses to the molding tool; and
one or more flow direction sensors communicatively connected to the main control unit, wherein the main control unit is configured to:
monitor a flow behavior of the resin mixture from the more than one injection points to the mold cavity using the one or more flow direction sensors; and
identify a direction of one or more resin flow fronts of the resin mixture based on the flow behavior.

2. The system of claim 1, wherein:
at least a first sensor of the one or more flow direction sensors is located within the molding tool; and
at least a second sensor of the one or more flow direction sensors is located on at least one venting hose of the one or more venting hoses, wherein the at least a second sensor comprises a capacitive sensor.

3. The system of claim 1, wherein:
the main control unit is communicatively connected to the more than one injection units; and
the main control unit comprises memory containing instructions configuring the main control unit to control the more than one injection units to supply the resin mixture within the mold cavity.

4. The system of claim 3, wherein the main control unit is configured to:
receive flow data from the one or more flow direction sensors; and
transmit one or more flow commands to the more than one injection units as a function of the flow data.

5. The system of claim 4, wherein:
receiving the flow data from the one or more flow direction sensors comprises identifying critical data within the flow data; and
the main control unit is configured to transmit the critical data to a display device.

6. The system of claim 4, wherein:
the flow data comprises one or more injection flow datums; and
the main control unit is configured to:
compare the one or more injection flow datums to one or more predefined targets; and
transmit the one or more flow commands to the more than one injection units as a function of the comparison.

7. The system of claim 6, wherein:
a first flow command of the one or more flow commands is transmitted to a first injection unit of the more than one injection units; and
a second flow command of the one or more flow commands is transmitted to a second injection unit of the more than one injection units, wherein the first flow command differs from the second flow command.

8. The system of claim 1, wherein the one or more flow direction sensors are configured to identify a position of one or more flow fronts of the resin mixture.

9. The system of claim 8, wherein the main control unit is configured to:
receive flow data from the one or more flow direction sensors; and
identify a convergence point of the one or more flow fronts as a function of the flow data.

10. The system of claim 9, wherein the main control unit is configured to transmit one or more flow commands to the more than one injection units as a function of the identified convergence point, wherein the one or more flow commands are configured to direct the resin mixture to the more than one resin outlets.

11. (canceled)

12. The system of claim 10, wherein at least one flow command of the one or more flow commands comprise an injection flow volume.

13. The system of claim 1, wherein at least one sensor of the one or more flow direction sensors comprises an air bubble sensor located at at least one resin outlet of the more than one resin outlets and wherein the air bubble sensor is configured to detect air bubbles in the resin mixture.

14. The system of claim 13, wherein the air bubble sensor comprises a capacitive sensor.

15. The system of claim 1, wherein:
the one or more venting hoses comprise a transparent material; and
the one or more flow direction sensors comprise at least one sensor configured to monitor the flow behavior through the transparent material.

16. The system of claim 1, wherein:
the one or more flow direction sensors comprise:
at least a first sensor located within the molding tool and configured to measure an internal pressure within the molding tool; and
at least a second sensor located outside of the molding tool and configured to measure an injection pressure; and
the main control unit is configured to:
transmit one or more flow commands to the more than one injection units as a function of the internal pressure and the injection pressure.

17. A method for carrying out an RTM (Resin Transfer Molding) process, the method comprising:
receiving a molding tool comprising an upper mold half and a lower mold half, wherein the upper mold half and lower mold half form a mold cavity configured for placement of a preform;
flowing, using more than one injection units, a resin mixture into the mold cavity, wherein the more than one injection units are fluidly connected to the molding tool through more than one injection points;
sensing, using one or more flow direction sensors, flow data of the resin mixture;
receiving, by a main control unit communicatively connected to the one or more flow direction sensors, the flow data;
monitoring, by the main control unit, a flow behavior of the resin mixture from the more than one injection points to the mold cavity using the flow data; and
identifying, by the main control unit, a direction of one or more resin flow fronts of the resin mixture based on the flow behavior.

18. The method of claim 17, wherein:
the molding tool comprises more than one resin outlets fluidly connecting one or more venting hoses to the molding tool, wherein the one or more venting hoses are configured to expel an excess of the resin mixture within the mold cavity; and
at least a second sensor of the one or more flow direction sensors is located on at least one venting hose of the one or more venting hoses, wherein the at least a second sensor comprises a capacitive sensor.

19. The method of claim 17, wherein:
the main control unit is communicatively connected to the more than one injection units; and
monitoring, by the main control unit, the flow behavior of the resin mixture comprises controlling, by the main control unit, the more than one injection units to supply the resin mixture within the mold cavity.

20. The method of claim 17, wherein monitoring, by the main control unit, the flow behavior of the resin mixture comprises transmitting, by the main control unit, one or more flow commands to the more than one injection units as a function of the flow data.

21. The method of claim 17, wherein:
receiving, by the main control unit communicatively connected to the one or more flow direction sensors, the flow data comprises identifying critical data within the flow data; and
the method further comprises transmitting, by the main control unit, the critical data to a display device.

22. The method of claim 20, wherein:
the flow data comprises one or more injection flow datums; and
monitoring, by the main control unit, the flow behavior of the resin mixture comprises:
comparing the one or more injection flow datums to one or more predefined targets; and
transmitting the one or more flow commands to the more than one injection units as a function of the comparison.

23. The method of claim 22, wherein:
a first flow command of the one or more flow commands is transmitted to a first injection unit of the more than one injection units; and
a second flow command of the one or more flow commands is transmitted to a second injection unit of the more than one injection units, wherein the first flow command differs from the second flow command.

24. The method of claim 17, wherein the one or more flow direction sensors are configured to identify a position of one or more flow fronts of the resin mixture.

25. The method of claim 24, wherein receiving, by the main control unit communicatively connected to the one or more flow direction sensors, the flow data comprises identifying a convergence point of the one or more flow fronts as a function of the flow data.

26. The method of claim 25, wherein monitoring, by the main control unit, the flow behavior of the resin mixture comprises transmitting one or more flow commands to the more than one injection units as a function of the identified convergence point, wherein the one or more flow commands are configured to direct the resin mixture to one more than one resin outlets on the molding tool.

27. The method of claim 17, wherein the main control unit is further configured to control the more than one injection units to modify the direction of the one or more resin flow fronts.

28. The method of claim 26, wherein at least one flow command of the one or more flow commands comprise an injection volume.

29. The method of claim 17, wherein at least one sensor of the one or more flow direction sensors comprises an air bubble sensor located at at least one resin outlet of more than one resin outlets located on the molding tool and wherein the air bubble sensor is configured to detect air bubbles in the resin mixture.

30. The method of claim 17, wherein:
the one or more flow direction sensors comprise:
at least a first sensor located within the molding tool and configured to measure an internal pressure within the molding tool; and
at least a second sensors located outside of the molding tool and configured to measure an injection pressure; and
monitoring, by the main control unit, the flow behavior of the resin mixture comprises transmitting one or more flow commands to the more than one injection units as a function of the internal pressure and the injection pressure.

31. The system of claim 1, wherein the main control unit is further configured to control the more than one injection units to modify the direction of the one or more resin flow fronts.
